(19) United States
(12) Patent Application Publication
(10) Pub. No.: US 2026/0059520 A1
(43) Pub. Date: Feb. 26, 2026

(54) POWER AMPLIFIER EFFICIENCY BASED RESOURCE SCHEDULER

(71) Applicant: Samsung Electronics Co., Ltd., Suwon-si (KR)

(72) Inventors: Mehmet Mert Sahin, Frisco, TX (US); Ahmad AlAmmouri, Richardson, TX (US); Chance Anthony Tarver, Arlington, TX (US); Young Han Nam, Plano, TX (US)

(21) Appl. No.: 19/204,346

(22) Filed: May 9, 2025

Related U.S. Application Data
(60) Provisional application No. 63/685,651, filed on Aug. 21, 2024.

(51) Int. Cl. H04W 72/121; H04W 72/50

(52) U.S. Cl. CPC H04W 72/121; H04W 72/535

(57) ABSTRACT

Methods and systems for power amplifier efficiency-based resource scheduling. A method includes receiving packet resource block (PRB) utilization information of PRBs using a distributed unit (DU) of a digital envelope tracking (DET) system, grouping user equipments (UEs) into a first UE group and a second UE group based on a delay tolerance limit of each UE, and determining whether data is ready for transmission based on a number of UEs in the first UE group and a number of UEs in the second UE group.

### CROSS-REFERENCE TO RELATED APPLICATIONS AND CLAIM OF PRIORITY

The present application claims priority to U.S. Provisional Patent Application No. 63/685,651, filed on Aug. 21, 2024. The contents of the above-identified patent documents are incorporated herein by reference.

### TECHNICAL FIELD

The present disclosure relates generally to wireless communication systems. more specifically, the present disclosure relates to a system and method for power amplifier efficiency-based resource scheduling.

### BACKGROUND

As wireless networks are becoming prevalent across industries and residential areas and handling more advanced services and applications requiring high data rates, networks are becoming denser with more antennas, larger bandwidths, and more frequency bands. Energy consumption of wireless networks accounts for a substantial portion of the total operator cost. Most of the energy consumption comes from the radio access network and in particular from the active antenna unit. Discontinuous transmission is a hardware feature for networks enabling the deactivation of some components of a base station, such as power amplifiers and low noise amplifier, during empty transmission time intervals. However, in low and medium traffic levels, the overall energy efficiency of the wireless network degrades.

Accordingly, there is a need for systems and methods for improved resource scheduling that overcome these challenges.

### SUMMARY

The present disclosure relates generally to wireless communication systems and, more specifically, the present disclosure relates to a system and method for power amplifier efficiency-based resource scheduling.

In one embodiment, a method is provided. The method includes receiving packet resource block (PRB) utilization information of PRBs using a distributed unit (DU) of a digital envelope tracking (DET) system, grouping user equipments (UEs) into a first UE group and a second UE group based on a delay tolerance limit of each UE, and determining whether data is ready for transmission based on a number of UEs in the first UE group and a number of UEs in the second UE group.

In another embodiment, an electronic device is provided. The electronic device includes a transceiver configured to transmit data and a processor operably coupled to the transceiver. The processor configured to cause the electronic device to receive packet resource block (PRB) utilization information of PRBs using a distributed unit (DU) of a digital envelope tracking (DET) system, group user equipments (UEs) into a first UE group and a second UE group based on a delay tolerance limit of each UE, and determine whether data is ready for transmission based on a number of UEs in the first UE group and a number of UEs in the second UE group.

In yet another embodiment, a non-transitory computer-readable medium is provided. The non-transitory computer-readable medium includes program code, that when executed by at least one processor of an electronic device, causes the electronic device to receive packet resource block (PRB) utilization information of PRBs using a distributed unit (DU) of a digital envelope tracking (DET) system, group user equipments (UEs) into a first UE group and a second UE group based on a delay tolerance limit of each UE, and determine whether data is ready for transmission based on a number of UEs in the first UE group and a number of UEs in the second UE group.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example digital envelope of a power amplifier;

FIG. 5 illustrates an example power added efficiency curve of a digital envelope tracking system according to embodiments of the present disclosure;

FIG. 6A illustrates an example method of power amplifier efficiency-based resource scheduling according to embodiments of the present disclosure;

FIG. 6B illustrates an example flow chart for a scheduler implementing the method of power amplifier efficiency-based resource scheduling of FIG. 6A according to embodiments of the present disclosure;

FIG. 7A illustrates an example method of data partitioning for power amplifier efficiency-based resource scheduling according to embodiments of the present disclosure;

FIG. 7B illustrates an example method of data partitioning for power amplifier efficiency-based resource scheduling according to embodiments of the present disclosure; and

FIG. 8 illustrates an example method of zone partitioning using open radio access network signaling for power amplifier efficiency-based resource scheduling according to embodiments of the present disclosure.

### DETAILED DESCRIPTION

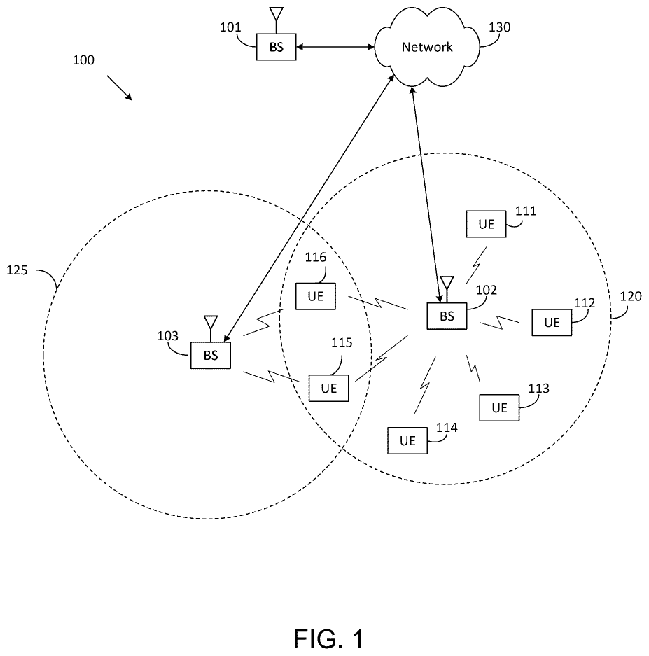

FIG. 1 through FIG. 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, energy consumption of wireless networks accounts for a substantial portion of the total operator cost. Most of the energy consumption comes from the radio access network and in particular from the active antenna unit. Discontinuous transmission is a hardware feature for networks enabling the deactivation of some components of a base station, such as power amplifiers (PAS), during empty transmission time intervals (TTIs). To improve efficiency of the PA, the PA is chosen to match the peak power required and is most energy efficient when output power is close to the peak power. However, in varying load scenarios, the peak power and maximum power amplifier efficiency (PAE) are often not reached. Digital envelope tracking (DET) may be used to improve PA efficiency by adjusting the supply voltage of the PA based on the amplitude of the input signal. Saturation points of the PA are marked where the PAE stays constant at the maximum value even though the output power increases. Saturation points also vary with different DC bias voltage applied to the PA. A reduced DC voltage improves energy efficiency since the power consumption is proportional to DC voltage and electric current flowing across the circuit. The PA bias voltage may be switched to different values, for example, if the power per PA after the power back-off should be smaller than a threshold power assuming certain peak-to-average power (PAPR) constraint.

Accordingly, the present disclosure provides systems and methods for power amplifier efficiency-based resource scheduling. As described herein, the present disclosure includes a packet scheduler mechanism that constrains physical resource block (PRB) utilization is provided when envelope tracking system is present in the radio frequency (RF) chain. Based on allocated PRBs that another scheduler outputs, provided mechanism performs three actions: (1) delay the transmission, (2) allow the transmission, and (3) partition packets into two groups where one group is transmitted, the other one is delayed. By these actions, provided mechanism confines the number of allocated PRBs during transmission into certain zones corresponding to power amplifier efficiency. The aim of this embodiment is to facilitate using the highest possible power amplifier efficiency levels that reduces overall power consumption of the network.

The present disclosure further provides for information exchange between the distributed unit (DU) and the radio unit (RU) to enable PAE-based scheduler at the DU. The RU may need to indicate its PAE measurement capabilities to the DU and provide the DU with the PAE information. In one option, the RU constructs the PAE curves and report them directly to the DU. The DU can partition the zones and use them for energy-efficient scheduling. In another option, the RU constructs the zones and report the different zones to the DU.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

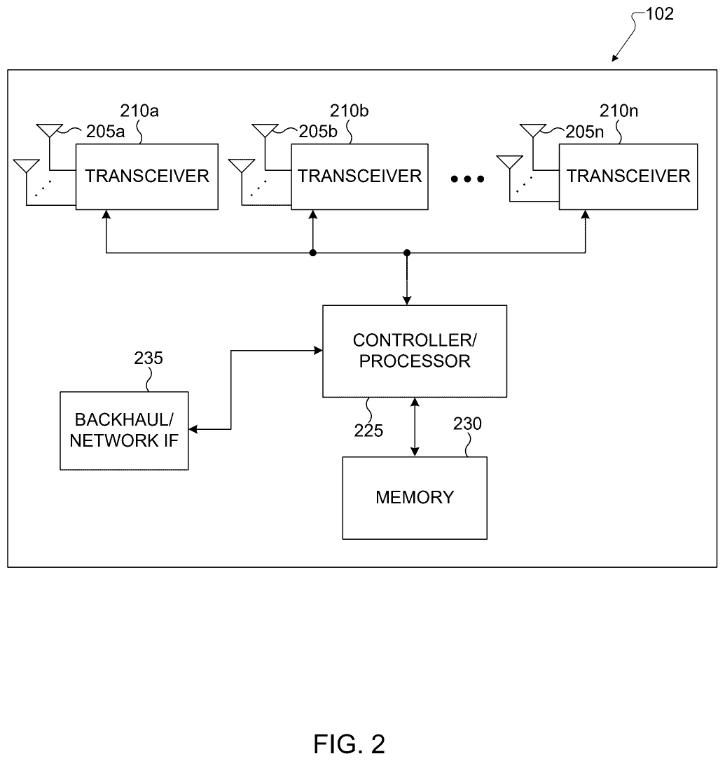

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted, and additional components could be added according to particular needs.

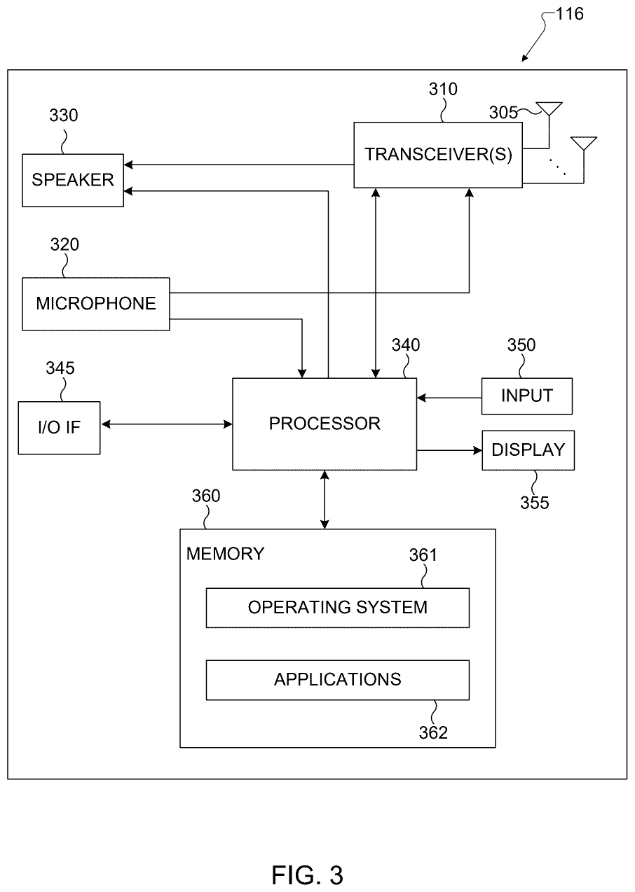

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

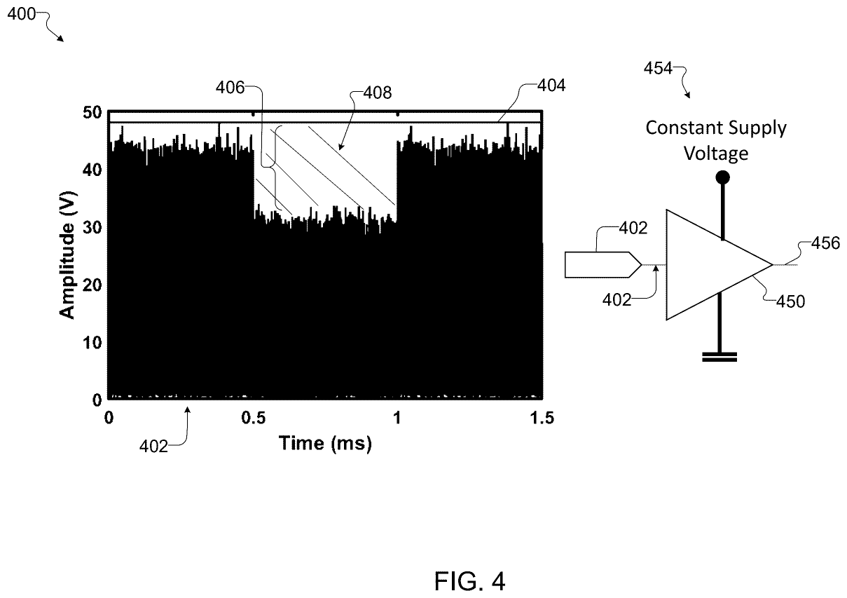

The TX processing circuitry of the gNB 101 may also include one or more power amplifiers coupled to one or more digital-to-analog converters and configured to amplify the baseband signal prior to transmission using the antenna. The one or more power amplifiers receive a supply voltage sufficient to cover the signal envelope of the baseband signal, as shown in FIG. 4.

FIG. 4 illustrates an example digital envelope 400 of a power amplifier 450. As shown in FIG. 4, the digital envelope 400, which may be represented as amplitude voltage over time, includes a RF envelope 402 representative of a baseband signal supplied to the power amplifier 450 from the DAC 452. In response to receiving the RF envelope 402, the power amplifier 450, using a constant supply voltage source 454 provides a PA supply voltage 404 to generate an output signal 456. The PA supply voltage 404 may need to have a voltage level (e.g., 48 volts as shown) greater than the RF envelope 402 to be effective. The RF envelope 402, however, fluctuates over time, creating a gap 406 between the RF envelope 402 and the PA supply voltage 404. The gap 406 creates an area of wasted energy 408 as the PA supply voltage 404 remains constant despite the RF envelope 402 changing voltage levels over time.

Further, the gap 406 forces the power amplifier 450 to operate in a power backoff mode. In a power backoff mode, the power amplifier 450 operates at a reduced power level below its highest output, intentionally lowering the signal received from the DAC 452 to maintain linearity and avoid distortion, especially when dealing with signals that have large peaks in power, ensuring the power amplifier 450 stays within its linear operating region even during high signal bursts from the DAC 452. While operating in backoff mode can improve signal quality, it usually comes at the cost of reduced power efficiency as the power amplifier 450 is not operating at its peak power output. In particular, when the power amplifier 450 operates in a power backoff mode, its power added efficiency (PAE) typically decreases significantly, reducing the effectiveness of the power amplifier 450 in amplifying the RF envelope 402.

Although FIG. 4 illustrates one example of a digital envelope of a power amplifier, various changes may be made to FIG. 4. For example, the baseband signal may fluctuate between more than two voltage levels, such as between three or more voltage levels, such as between 4 or more voltage levels.

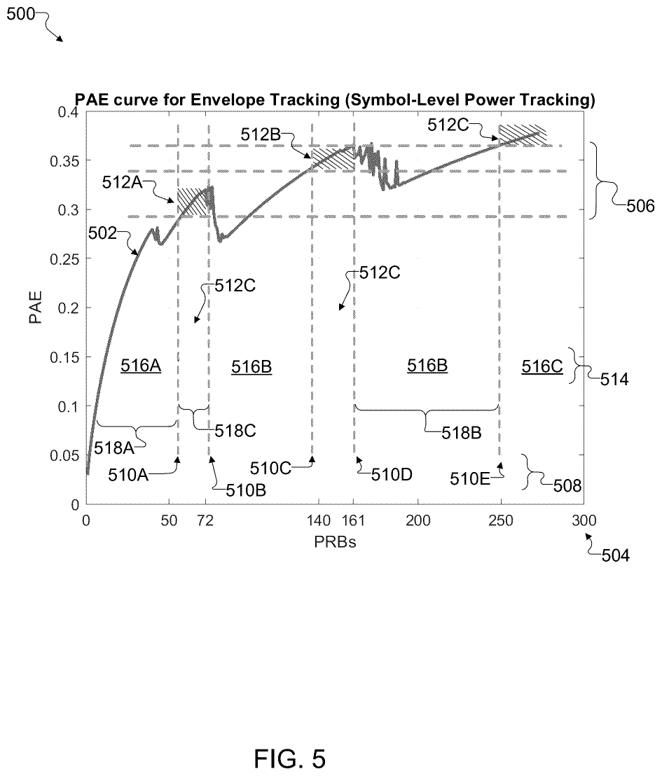

To improve power efficiency, the area of wasted energy 408 should be minimized between the RF envelope 402 and the PA supply voltage 404. This may be accomplished by configuring the power amplifier 450 to apply voltage levels that track or change with the RF envelope 402, for example, in a digital envelope tracking system. Despite adjustment of bias voltage levels to track the RF load, low and medium traffic levels reduce overall PAE of the system. For example, another NW packet scheduler populates the transmission on physical resource blocks (PRBs) assuming the highest MCS index is used for each UEs to maximize the sum throughput or fairness among UEs. However, in low and medium traffic levels, where full PRB allocation with maximum PSD (leading to maximum power amplifier efficiency) is not reached, the overall energy efficiency of the wireless network degrades. As such, a power amplifier efficiency-based resource scheduler having a PAE diagram is shown in FIG. 5.

FIG. 5 illustrates an example power amplifier efficiency (PAE) diagram 500 of a digital envelope tracking system according to embodiments of the present disclosure. The embodiment of the PAE diagram 500 shown in FIG. 5 is for illustration only. Other embodiments of the PAE diagram 500 could be used without departing from the scope of this disclosure.

As shown in FIG. 5A, the PAE diagram 500 includes a PAE curve 502 as a function of a total number of PRBs 504 and a PAE level 506 of a power amplifier. The PAE curve 502 includes peaks of PAE level 506 at certain PRB levels 508 having a number of PRBs. For example, a first PRB level 510A may include 50 total PRBs, a second PRB level 510B may include 72 total PRBs, a third PRB level 510C may include 140 total PRBs, a fourth PRB level 510D may include 161 total PRBs, and a fifth PRB level 510E may include 250 total PRBs. The PRB level 508, however, are determined by the other scheduler and may include different total number of PRBs 504 having different PRB levels 508.

The PAE peaks of the PAE curve 502 occur between certain PRB levels 508, such as a first peak 512A between first PRB level 510A and second PRB level 510B, a second peak 512B between fifth PRB level 510E and fourth PRB level 510D, and a third peak 512C after fifth PRB level 510E. These peaks help define a plurality of PRB zones 514 (e.g., zones between peaks and at peaks). For example, the plurality of PRB zones 514 includes a first PRB zone 516A having a first range of PRBs 518A of the total number of PRBs 504, a second PRB zone 516B having a second range of PRBs 518B of the total number of PRBs 504, and a third PRB zone 516C having a third range of PRBs 518C of the total number of PRBs 504. As shown, the first PRB zone 516A may be a startup or low-level PRB zone, which may be defined by a PRB level 508 before the first peak 512A, such as by the first PRB level 510A. The second PRB zone 516B is a PRB zone between the PAE peaks of the power amplifier. For example, the second PRB zone 516B may be a zone between the second PRB level 510B and the third PRB level 510C (e.g., between the first peak 512A and the second peak 512B) or a zone between the fourth PRB level 510D and the fifth PRB level 510E (e.g., between the second peak 512B and the third peak 512C), or both. The third PRB zone 516C is a PRB zone corresponding to a PAE peak. For example, the third PRB zone 516C may be a PRB zone that encompasses the first peak 512A, a PRB zone that encompasses the second peak 512B, a PRB zone that encompasses the third peak 512C, or a combination thereof.

The second PRB level 510B and the fourth PRB level 510D are at the point where maximum PA efficiency can be reached at the corresponding PA DC bias voltage. These levels are set as end of regions categorized as the third PRB zone 516C together with maximum number of PRB, 273. After the second PRB level 510B and the fourth PRB level 510D, the PA efficiency starts to drop where bias voltage transition happens. Start point of regions categorized into the third PRB zone 516C can be found using either (i) a PRB number whose associated PA efficiency value is x much lower than the PA efficiency value corresponding to end of the third PRB zone 516C (e.g., x=0.02), or (ii) an x amount of PRB less than the PRB number corresponding to end of the third PRB zone 516C (e.g., x=5). Also, in the last region (e.g., above the fifth PRB level 510E) categorized as the third PRB zone 516C is depicted in between PRB numbers of 248 and 273 where close to full power transmission increases PAE in current Radio Units (RUs). When the DET system switches to another bias voltage level, the PA efficiency drops. The PRB level 508 corresponding to end of the third PRB zone 516C also defines the start of the second PRB zone 516B. The second PRB zone 516B lasts up to start of a subsequent third PRB zone 516C. Finally, the first PRB zone 516A starts from 0 PRB and ends at the PRB number where first the third PRB zone 516C starts.

In an ORAN setup, the DU is responsible for scheduling and resource allocation while each RU can have its own PA efficiency curve (i.e., different zones in the PAE diagram 500). Exchange of information is used between the DU and RU. For example, the RU can inform the DU of its PAE and its PAE measurement capabilities through M-plane. To do so, the DU requests that the RU report the PAE information prior to performing the zone partitioning for a scheduling operation. When the PAE information changes with time, the RU may periodically monitor and measure the PAE and update the DU through M-plane. The PAE information may be formatted as a table that maps each number of PRBs to the measured PAE at the RU. Alternatively, the PAE information may be formatted as a sequence of N+1 positive real numbers corresponding to the measured PAE values for 0, 1, . . . , N number of scheduled PRBs where N is the maximum number of PRBs for the component carrier.

The RU may measure its PAE by sweeping the number of scheduled PRBs. For example, the RU may measure the PAE during data transmissions (PDSCH). If the RU needs to measure the PAE for a certain number of PRBs, different alternatives may be used, such as (i) having the DU periodically transmit training sequences which are time-multiplexed by sweeping a total number of PRBs that maybe need to update the PAE table or (ii) having the RU request the transmission of a certain number of PRBs from the DU through M-plane. The DU then transmits reference signals confined in a requested number of PRBs with a maximum power spectral density (PSD).

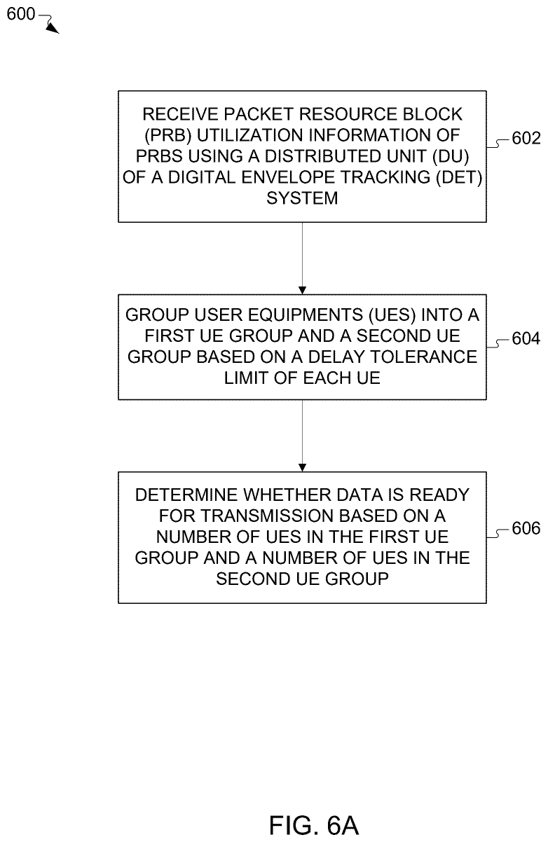

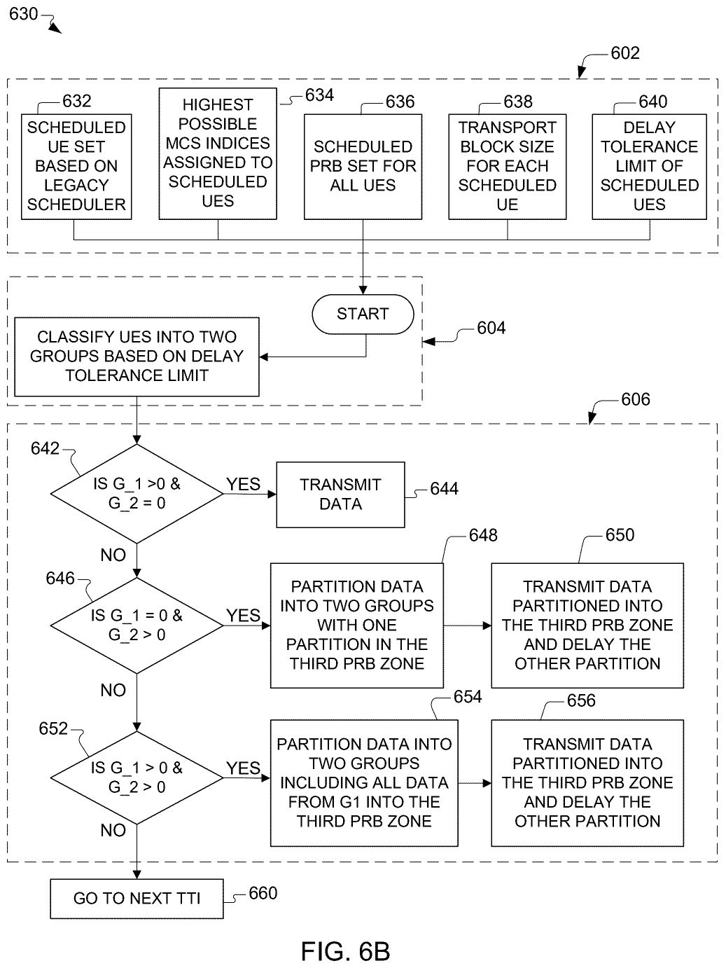

As shown in FIG. 5, the PAE diagram 500 constrains the PRB utilization per TTI when the envelope tracking system is present in the RF chain to maximize the power amplifier efficiency. In particular, the PAE diagram 500 shows power amplifier efficiency values over allocated PRBs with maximum PSD under the use of 4-level symbol power tracking. The total number of PRBs 504 set is from 0 to 273. As allocated PRBs of other scheduler decrease, the envelope tracking system attempts to lower DC bias voltage of power amplifier to reduce power consumption. However, the PAE varies sharply around the DC bias voltage switching points. These fluctuations can be seen in the PAE diagram 500 at certain PRB levels. The PAE diagram 500 arranges the number of PRBs for transmission at each TTI to get rid of these fluctuations by packet partitioning and/or data delaying. The scheduler constrains the number of PRBs for transmission by utilizing a look-up table created via power amplifier measurements corresponding to certain number of allocated PRB as exemplified in FIG. 6.

Scheduling operations inside the plurality of PRB zones 514 may be performed after another scheduler determines the number of PRBs with maximum achievable MCS level and maximum PSD level. For example, in the first PRB zone 516A, the provided scheduler activates u-Sleep mode and delays the data transmission. The aim is to collect more data to transmit with higher PRB levels. In the second PRB zone 516B, the provided scheduler splits the transmission packet, which is the output of the other scheduler, into two chunks. The split is arranged in a way that one chunk end up allocating the closest target PRB level. As shown in FIG. 5, the split happening in first the second PRB zone 516B creates a chunk populating 72 PRBs and this chunk is transmitted through the wireless channel. The remaining data is delayed to next TTI. Similarly, the split in the second PRB zone 516B creates a chunk of data allocating 159 PRBs which is transmitted at the current TTI, and remaining data is delayed. In the third PRB zone 516C, if the populated PRB set from the other scheduler is at the third PRB zone 516C, the provided scheduler does not perform any additional operations and transmission occurs.

Although FIG. 5 illustrates one example of a power added efficiency curve of a digital envelope tracking system, various changes may be made to FIG. 5. For example, the PAE curve may include a different number of peaks, such as two or more, such as four or more, that occur at different PRB levels creating a more PRB zones or less PRB zones, such as more or less of the second PRB zone or more or less of the third PRB zone.

FIG. 6A illustrates an example method 600 of power amplifier efficiency-based resource scheduling according to embodiments of the present disclosure. FIG. 6B illustrates an example flow chart for a scheduler implementing the method of power amplifier efficiency-based resource scheduling of FIG. 6A according to embodiments of the present disclosure. An embodiment of the method illustrated in FIGS. 6A-6B is for illustration only. One or more of the components illustrated in FIGS. 6A-6B may be implemented in specialized circuitry configured to perform the noted functions or one or more of the components may be implemented by one or more processors executing instructions to perform the noted functions. Other embodiments of power amplifier efficiency-based resource scheduling could be used without departing from the scope of this disclosure.

As shown in FIGS. 6A and 6B, packet resource block (PRB) utilization information of PRBs is received using a distributed unit (DU) of a digital envelope tracking (DET) system at step 602. For example, for a given TTI, another scheduler determines the set of scheduled PRBs for all UE, [symbol] . In particular, a media access control (MAC) layer in the network has packet scheduler for allocating time-frequency-spatial resources to the User Equipments (UEs) based on Channel State Information (CSI) and Buffer Status Report (BSR) of users. The network utilizes PDCCH to transfer Downlink Control Information (DCI) Format 1_0 or 1_1 to specify the allocated resources to UEs to schedule PDSCH transmission. The resources tend to be changed with every transmission slot so that scheduling is adaptive to the current propagation channel conditions, user data-rate requirements, and network load. The operations done by the other scheduler at the network without energy efficiency (EE) features for a given transmission time interval (TTI) include having the network select a primary user based on proportional fair by ensuring the minimum Quality of Service (QoS) is met and creating the physical resource block (PRB) set (block 632) that is populated by scheduled primary users to flush out their buffers where a minimum scheduling unit in the frequency domain defines the PRB. The network finds the remaining user set to serve together with primary users (e.g., using MU-MIMO user pairing), and allocates power to all scheduled users by assigning the highest possible MCS indices (block 634) to them. For the other scheduler to perform its operation, all users may need to report their buffer status and channel quality indicator (CQI). Mathematically, the scheduled UE set, [symbol] , (block 636) including total K UEs denote as [symbol] ={1, 2, . . . , K} and are scheduled PRB set for all users denote as [symbol] ={ [symbol] ₁, [symbol] ₂, . . . , [symbol] _{K}} where Fᵢ corresponds to i^{th} UE's allocated PRB set. The number of information bits, N_{info}, is calculated by 3GPP as follows:

$${N}_{info} = {N}_{RE} \times M O \times T C R \times {N}_{L} ,$$

where N_{RE} is the total number of resource elements available for data transfer and N_{L} is the total number of layers. The modulation order, MO, and the target code rate, TCR, are both pulled out from an MCS table and depend on the SINR of a user. The PRB information may also include the transport block size (block 638) along with the delay tolerance limit (block 640) for each scheduled UE.

User equipments (UEs) are grouped into a first UE group and a second UE group based on a delay tolerance limit of each UE at step 604. For example, a first UE group G₁ includes UEs which have already reached the delay tolerance limit and a second UE group G₂ includes UEs that have not reached their delay tolerance limit. Further, receiving the PRB utilization information may include receiving PRB zone partitioning from a radio unit (RU) based on power amplifier efficiency values or receiving power amplifier efficiency values from the RU and determining PRB zone partitioning using the DU.

The method 600 includes determining whether data is ready for transmission based on a number of UEs in the first UE group G₁ and a number of UEs in the second UE group G₂ at step 606. For example, determining whether the data is ready for transmission based on the number of UEs in the first UE group G₁ and the number of UEs in the second UE group G₂ includes determining whether the number of UEs in the first UE group G₁ is greater than zero and whether the number of UEs in the second UE group G₂ is zero (block 642), and upon determining that the number of UEs in the first UE group G₁ is greater than zero and that the number of UEs in the second UE group G₂ is zero, transmitting the data (block 644). Upon determining that the number of UEs in the first UE group G is not greater than zero, the method 600 includes determining whether the number of UEs in the second UE group G₂ is greater than zero (block 646). Upon determining that the number of UEs in the second UE group G₂ s is greater than zero, the method 600 includes determining whether to transmit the data, delay transmission of the data to a subsequent transmission time interval, or partition the data based on a total number of PRBs to transmit. For example, to determine whether to transmit the data, delay transmission of the data to a subsequent transmission time interval, or partition the data based on a total number of PRBs to transmit, the method 600 includes determining which PRB zone is invoked based on the total number of PRBs that may be required to transmit, where the PRB zones include a first zone having a first range of PRBs, a second zone having a second range of PRBs, and a third zone having a third range of PRBs. Upon determining that the first zone is invoked (e.g., the total number of PRBs is fully within the first zone), the data is transmitted. Upon determining that the second zone is invoked (e.g., the total number of PRBs is within the second zone), the data is partitioned into a first data group and a second data group (block 648), where the first data group is transmitted and the second data group is delayed (block 650). Upon determining that the third zone is invoked (e.g., the total number of PRBs is within the third zone), the data is transmitted.

Additionally, determining whether the data is ready for transmission based on the number of UEs in the first UE group G₁ and the number of UEs in the second UE group G₂ further includes, upon determining that the number of UEs in the first UE group G₁ is greater than zero and that that the number of UEs in the second UE group G₂ is greater than zero (block 652), determining whether to transmit the data, delay transmission of the data to a subsequent transmission time interval, or partition the data based on a total number of PRBs that may be required to transmit. To do so, the method 600 includes determining which PRB zone is invoked based on the total number of PRBs that may be required to transmit. Upon determining that the first zone is invoked (e.g., the total number of PRBs is fully within the first zone), the data is transmitted. Upon determining that the second zone is invoked (e.g., the total number of PRBs is within the second zone), partitioning the data into a first data group and a second data group where all data from the first UE group G₁ is included in the first data group (block 654), then the first data group is transmitted and the second data group is delayed (block 656). Upon determining that the third zone is invoked (e.g., the total number of PRBs is within the second zone), the data is transmitted. The scheduler algorithm may then proceed to a subsequent TTI (block 660).

In other words, if the set G₂ is empty (|G₂|=0) but G₁ is not empty (|G₁|>0), no change is applied into the transmission since data from delay intolerant UEs should be delivered as soon as possible. If the set G₁ is empty (|G₁|=0) but G₂ is not (|G₂|>0), the scheduler algorithm 630 partitions the data into two groups aiming one partition including all data from G₁ is in the third PRB zone 516C and it is transmitted. The scheduler delays the other partition to next TTI. If the set G₁ is empty (|G₁|=0) but G₂ is not (|G₂|>0), the scheduler partitions the data into two groups aiming one partition includes all data from G₁ This partition is in the third PRB zone 516C and it is transmitted. The scheduler delays the other partition to next TTI. If the set G₁ is empty (|G₁|=0) but G₂ is not (|G₂|>0), there is no data to transmit, therefore, the network goes into u-Sleep mode.

Although FIGS. 6A-6B illustrates one example method 600 of power amplifier efficiency-based resource scheduling, various changes may be made to FIGS. 6A-6B. For example, while shown as a series of steps, various steps in FIGS. 6A-6B could overlap, occur in parallel, occur in a different order, or occur any number of times.

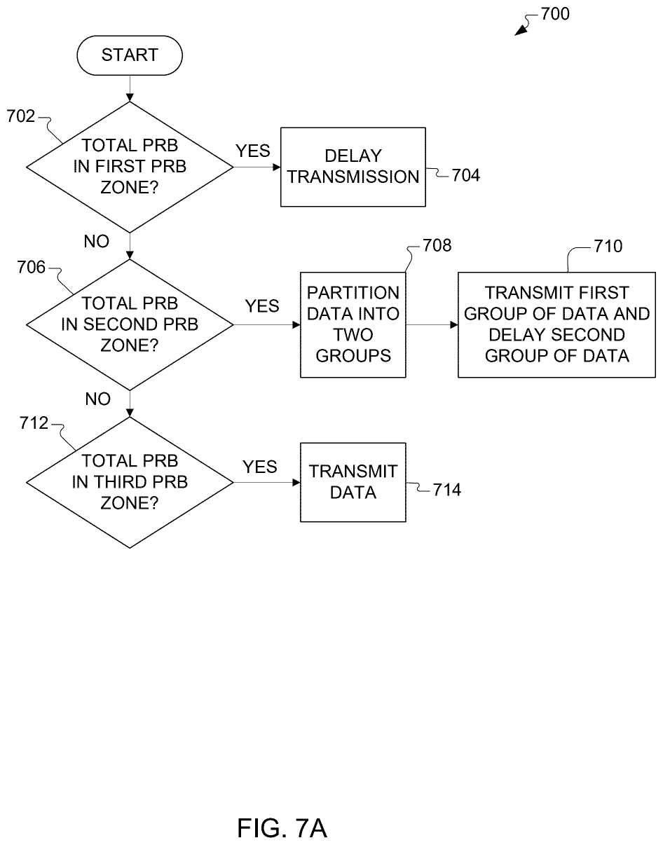

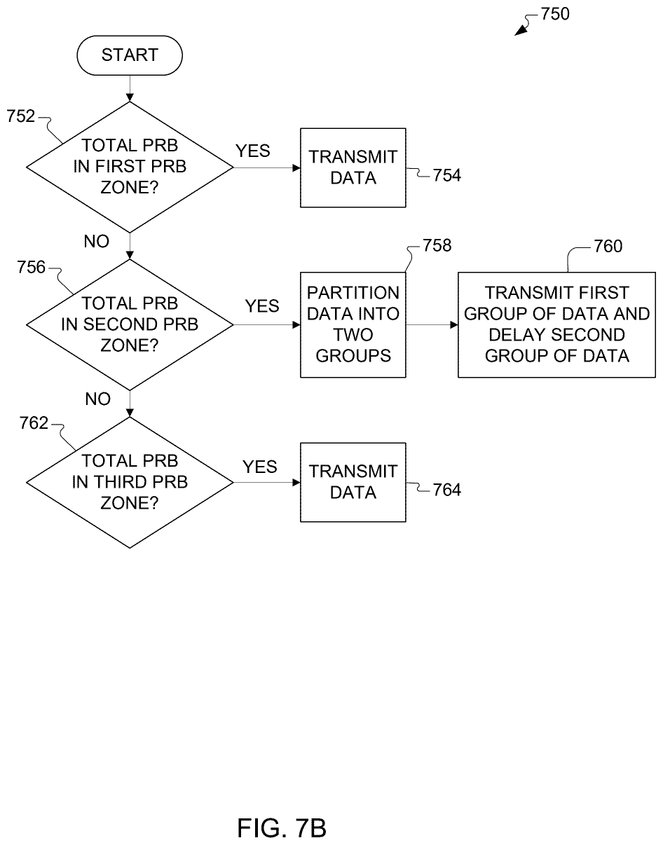

FIGS. 7A-7B illustrate example methods 700, 750 of data partitioning for power amplifier efficiency-based resource scheduling according to embodiments of the present disclosure. In particular, FIG. 7A illustrates an example method of data partitioning for power amplifier efficiency-based resource scheduling when no UEs have reached their delay tolerance limit and FIG. 7B illustrates an example method of data partitioning for power amplifier efficiency-based resource scheduling when at least one UE has reached its delay tolerance limit. The embodiment of the example methods 700, 750 of data partitioning for power amplifier efficiency-based resource scheduling shown in FIGS. 7A-7B are for illustration only. One or more of the components illustrated in FIGS. 6A-6B may be implemented in specialized circuitry configured to perform the noted functions or one or more of the components may be implemented by one or more processors executing instructions to perform the noted functions. Other embodiments of power amplifier efficiency-based resource scheduling could be used without departing from the scope of this disclosure.

As shown in FIG. 7A, upon determining that no UEs have reached their delay tolerance limit (e.g., at step 648 of the scheduler algorithm 630 of FIGS. 6A-6B), the total number of PRBs is evaluated for presence in the first PRB zone at step 702. For example, if total number of PRBs is in the first PRB zone 516A, the scheduler algorithm 630 delays the transmission (step 704) leading the network to get into u-Sleep mode. If the total PRBs to be transmitted are not found to be completely in the first PRB zone, the method 700 continues to step 706.

The total PRBs to be transmitted is evaluated for presence in the second PRB zone at step 706. For example, if total number of PRBs is in the second PRB zone 516B, the scheduler algorithm 630 partitions the scheduled data from the other scheduler into two groups at step 708. Partition is done in a way that number of PRBs in first group is in the closest the third PRB zone 516C to maximize PA efficiency. Scheduler only transmits first group of data and delays the rest of the data at step 710. If the total PRBs to be transmitted are not found to be completely in the second PRB zone, the method 700 continues to step 712.

The total PRBs to be transmitted is evaluated for presence in the third PRB zone at step 712. For example, if total number of PRBs is in the third PRB zone 516C, no step is needed from the provided scheduler algorithm 630 and transmission occurs based on output of the other scheduler at step 714.

As shown in FIG. 7B, upon determining that UEs have reached their delay tolerance limit (e.g., at step 652 of the scheduler algorithm 630 of FIGS. 6A-6B), the total number of PRBs is evaluated for presence in the first PRB zone at step 752. For example, if total number of PRBs is in the first PRB zone 516A, no step is needed from the provided scheduler algorithm 630 and transmission occurs based on output of the other scheduler at step 754. If the total number of PRBs are not found to be completely in the first PRB zone, the method 700 continues to step 756.

The total number of PRBs to be transmitted is evaluated for presence in the second PRB zone at step 756. For example, if total number of PRBs is in the second PRB zone 516B, the scheduler algorithm 630 partitions the scheduled data which the other scheduler outputs into two groups at step 758. Partition is done in a way that first group includes all data of delay intolerant UEs from G₁. Scheduler also includes data of UEs from G₂ into first group to reach the PRB number in the closest the third PRB zone 516C which maximizes PA efficiency. Scheduler only transmits first group of data and delays the rest of the data at step 760. If the total number of PRBs are not found to be completely in the second PRB zone, the method 700 continues to step 762.

The total number of PRBs to be transmitted is evaluated for presence in the third PRB zone at step 762. For example, if total number of PRBs is in the third PRB zone 516C, no step is needed from the provided scheduler algorithm 630 and transmission occurs based on output of the other scheduler at step 764.

Although FIGS. 7A-7B illustrate example methods 700, 750 of data partitioning for power amplifier efficiency-based resource scheduling, various changes may be made to FIGS. 7A-7B. For example, while shown as a series of steps, various steps in FIGS. 7A-7B could overlap, occur in parallel, occur in a different order, or occur any number of times.

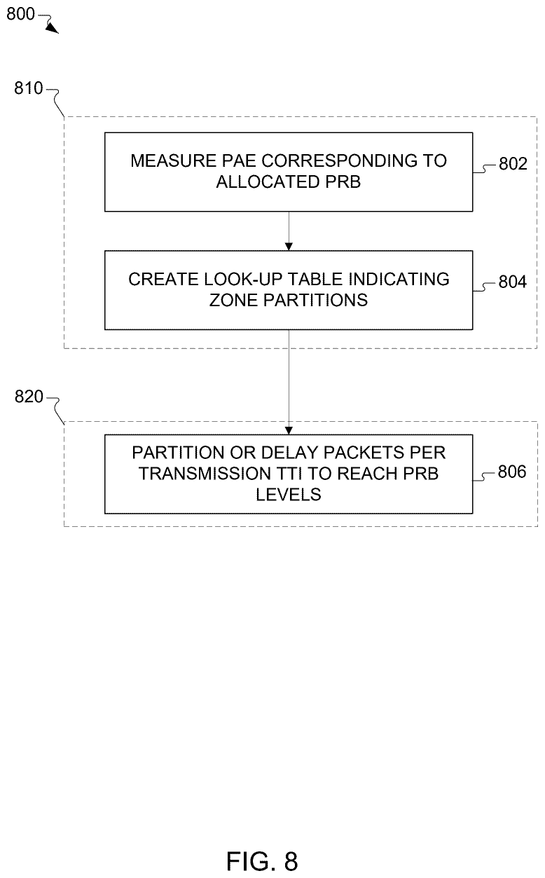

FIG. 8 illustrates an example method 800 of zone partitioning using open radio access network signaling for power amplifier efficiency-based resource scheduling according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of power amplifier efficiency-based resource scheduling could be used without departing from the scope of this disclosure.

In this alternative, each RU creates its own zone partitioning depending on PA efficiency values corresponding to allocated PRBs. Look-up table creation may be done before connecting to DU or after connecting to DU. Training sequences sweeping all possible PRB values can be used to find out corresponding PA efficiency values. Look-up table devised by RU may be transferred to DU by options listed below:

As shown in FIG. 8, PAE is measured corresponding to allocated PRB using the RU at step 802. For example, the RU 810 the PAE curves based on the power amplifier and PRB allocation.

A look-up table is created indicating zone partitions using the RU at step 804. For example, the RU 810 may create a look-up table based on the PAE curve measured from the power amplifier and the PRB allocation then create zone partitions based on the measured peaks of the PAE curve (e.g., the PAE curve 502 of FIG. 5). The RU may directly report the updated look-up table and zone partitioning to the DU 820 through M-plane. Alternatively, the DU 820 triggers the RU to report the most recent look-up table. Triggering may be done periodically. DU configures periodicity of trigger for the RU which may be several hours, days, months, or years.

Packets are partitioned or delayed per transmission TTI to reach PRB levels using the DU 820 at step 806. For example, the DU 820 may implement the method 600 (e.g., using at least one processor of the DU 820) to partition or delay packets based on PRB levels per TTI.

Although FIG. 8 illustrates one example method 800 of zone partitioning using open radio access network signaling for power amplifier efficiency-based resource scheduling, various changes may be made to FIG. 8. For example, in the case of many DC bias voltage possibilities in the power amplifier of the RU, the DU informs the RU (e.g., on C-plane or M-plane) what category of bias levels it should use as the DET bias levels from historically collected data to increase the bias voltage switching efficiency. To do so, the RU reports the supported PA bias voltage values to the DU in a capability signaling on M-plane.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving packet resource block (PRB) utilization information of PRBs using a distributed unit (DU) of a digital envelope tracking (DET) system;
grouping user equipments (UEs) into a first UE group and a second UE group based on a delay tolerance limit of each UE; and
determining whether data is ready for transmission based on a number of UEs in the first UE group and a number of UEs in the second UE group.

2. The method of claim 1, wherein receiving the PRB utilization information comprises:
receiving PRB zone partitioning from a radio unit (RU) based on power amplifier efficiency values; or
receiving power amplifier efficiency values from the RU and determining PRB zone partitioning using the DU.

3. The method of claim 1, wherein determining whether the data is ready for transmission based on the number of UEs in the first UE group and the number of UEs in the second UE group comprises:
determining whether the number of UEs in the first UE group is greater than zero and whether the number of UEs in the second UE group is zero; and
upon determining that the number of UEs in the first UE group is greater than zero and that the number of UEs in the second UE group is zero, transmitting the data.

4. The method of claim 3, wherein determining whether the data is ready for transmission based on the number of UEs in the first UE group and the number of UEs in the second UE group further comprises:
upon determining that the number of UEs in the first UE group is not greater than zero, determining whether the number of UEs in the second UE group is greater than zero; and
upon determining that the number of UEs in the second UE group is greater than zero, determining whether to transmit the data, delay transmission of the data to a subsequent transmission time interval, or partition the data based on a total number of PRBs to transmit.

5. The method of claim 4, wherein determining whether to transmit the data, delay transmission of the data to a subsequent transmission time interval, or partition the data based on a total number of PRBs to transmit comprises:
determining which PRB zone is invoked based on the total number of PRBs to transmit, wherein the PRB zones include a first zone having a first range of PRBs, a second zone having a second range of PRBs, and a third zone having a third range of PRBs;
upon determining that the first zone is invoked, transmitting the data;
upon determining that the second zone is invoked, partitioning the data into a first data group and a second data group, wherein the first data group is transmitted and the second data group is delayed; and
upon determining that the third zone is invoked, transmitting the data.

6. The method of claim 3, wherein determining whether the data is ready for transmission based on the number of UEs in the first UE group and the number of UEs in the second UE group further comprises:
upon determining that the number of UEs in the first UE group is greater than zero and that that the number of UEs in the second UE group is greater than zero, determining whether to transmit the data, delay transmission of the data to a subsequent transmission time interval, or partition the data based on a total number of PRBs to transmit.

7. The method of claim 6, wherein determining whether to transmit the data, delay transmission of the data to a subsequent transmission time interval, or partition the data based on a total number of PRBs to transmit comprises:
determining which PRB zone is invoked based on the total number of PRBs to transmit, wherein the PRB zones include a first zone having a first range of PRBs, a second zone having a second range of PRBs, and a third zone having a third range of PRBs;
upon determining that the first zone is invoked, transmitting the data;
upon determining that the second zone is invoked, partitioning the data into a first data group and a second data group, wherein the first data group is transmitted and the second data group is delayed and wherein all data from the first UE group is included in the first data group; and
upon determining that the third zone is invoked, transmitting the data.

8. An electronic device, comprising:
a transceiver configured to transmit data; and
a processor operably coupled to the transceiver, configured to cause the electronic device to:
receive packet resource block (PRB) utilization information of PRBs using a distributed unit (DU) of a digital envelope tracking (DET) system;
group user equipments (UEs) into a first UE group and a second UE group based on a delay tolerance limit of each UE; and
determine whether data is ready for transmission based on a number of UEs in the first UE group and a number of UEs in the second UE group.

9. The electronic device of claim 8, wherein the processor, when causing the electronic device to receive the PRB utilization information, is further configured to cause the electronic device to:
receive PRB zone partitioning from a radio unit (RU) based on power amplifier efficiency values; or
receive power amplifier efficiency values from the RU and determine PRB zone partitioning using the DU.

10. The electronic device of claim 8, wherein the processor, when causing the electronic device to determine whether the data is ready for transmission based on the number of UEs in the first UE group and the number of UEs in the second UE group, is further configured to cause the device to:
determine whether the number of UEs in the first UE group is greater than zero and whether the number of UEs in the second UE group is zero; and
upon determining that the number of UEs in the first UE group is greater than zero and that the number of UEs in the second UE group is zero, transmit the data.

11. The electronic device of claim 10, wherein the processor, when causing the electronic device to determine whether the data is ready for transmission based on the number of UEs in the first UE group and the number of UEs in the second UE group, is further configured to cause the device to:
upon determining that the number of UEs in the first UE group is not greater than zero, determine whether the number of UEs in the second UE group is greater than zero; and
upon determining that the number of UEs in the second UE group is greater than zero, determine whether to transmit the data, delay transmission of the data to a subsequent transmission time interval, or partition the data based on a total number of PRBs to transmit.

12. The electronic device of claim 11, wherein the processor, when causing the electronic device to determine whether to transmit the data, delay transmission of the data to a subsequent transmission time interval, or partition the data based on a total number of PRBs to transmit, is further configured to cause the device to:
determine which PRB zone is invoked based on the total number of PRBs to transmit, wherein the PRB zones include a first zone having a first range of PRBs, a second zone having a second range of PRBs, and a third zone having a third range of PRBs;
upon determining that the first zone is invoked, transmit the data;
upon determining that the second zone is invoked, partitioning the data into a first data group and a second data group, wherein the first data group is transmitted and the second data group is delayed; and
upon determining that the third zone is invoked, transmit the data.

13. The electronic device of claim 11, wherein the processor, when causing the electronic device to determine whether the data is ready for transmission based on the number of UEs in the first UE group and the number of UEs in the second UE group, is further configured to cause the device to:
upon determining that the number of UEs in the first UE group is greater than zero and that that the number of UEs in the second UE group is greater than zero, determine whether to transmit the data, delay transmission of the data to a subsequent transmission time interval, or partition the data based on a total number of PRBs to transmit.

14. The electronic device of claim 13, wherein the processor, when causing the electronic device to determine whether to transmit the data, delay transmission of the data to a subsequent transmission time interval, or partition the data based on a total number of PRBs to transmit, is further configured to cause the device to:
determine which PRB zone is invoked based on the total number of PRBs to transmit, wherein the PRB zones include a first zone having a first range of PRBs, a second zone having a second range of PRBs, and a third zone having a third range of PRBs;
upon determining that the first zone is invoked, transmit the data;
upon determining that the second zone is invoked, partitioning the data into a first data group and a second data group, wherein the first data group is transmitted and the second data group is delayed and wherein all data from the first UE group is included in the first data group; and
upon determining that the third zone is invoked, transmit the data.

15. A non-transitory computer-readable medium comprising program code, that when executed by at least one processor of an electronic device, causes the electronic device to:
receive packet resource block (PRB) utilization information of PRBs using a distributed unit (DU) of a digital envelope tracking (DET) system;
group user equipments (UEs) into a first UE group and a second UE group based on a delay tolerance limit of each UE; and
determine whether data is ready for transmission based on a number of UEs in the first UE group and a number of UEs in the second UE group.

16. The non-transitory computer-readable medium of claim 15, wherein the program code, that when executed by the at least one processor, causes the electronic device to receive the PRB utilization information, further comprises program code, that when executed by the at least one processor, causes the electronic device to:
receive PRB zone partitioning from a radio unit (RU) based on power amplifier efficiency values; or
receive power amplifier efficiency values from the RU and determine PRB zone partitioning using the DU.

17. The non-transitory computer-readable medium of claim 15, wherein the program code, that when executed by the at least one processor, causes the electronic device to determine whether the data is ready for transmission based on the number of UEs in the first UE group and the number of UEs in the second UE group, further comprises program code, that when executed by the at least one processor, causes the electronic device to:
determine whether the number of UEs in the first UE group is greater than zero and whether the number of UEs in the second UE group is zero; and
upon determining that the number of UEs in the first UE group is greater than zero and that the number of UEs in the second UE group is zero, transmit the data.

18. The non-transitory computer-readable medium of claim 17, wherein the program code, that when executed by the at least one processor, causes the electronic device to determine whether the data is ready for transmission based on the number of UEs in the first UE group and the number of UEs in the second UE group, further comprises program code, that when executed by the at least one processor, causes the electronic device to:
upon determining that the number of UEs in the first UE group is not greater than zero, determine whether the number of UEs in the second UE group is greater than zero; and
upon determining that the number of UEs in the second UE group is greater than zero, determine whether to transmit the data, delay transmission of the data to a subsequent transmission time interval, or partition the data based on a total number of PRBs to transmit.

19. The non-transitory computer-readable medium of claim 18, wherein the program code, that when executed by the at least one processor, causes the electronic device to determine whether to transmit the data, delay transmission of the data to a subsequent transmission time interval, or partition the data based on a total number of PRBs to transmit, further comprises program code, that when executed by the at least one processor, causes the electronic device to:
determine which PRB zone is invoked based on the total number of PRBs to transmit, wherein the PRB zones include a first zone having a first range of PRBs, a second zone having a second range of PRBs, and a third zone having a third range of PRBs;
upon determining that the first zone is invoked, transmit the data;
upon determining that the second zone is invoked, partitioning the data into a first data group and a second data group, wherein the first data group is transmitted and the second data group is delayed; and
upon determining that the third zone is invoked, transmit the data.

20. The non-transitory computer-readable medium of claim 18, wherein the program code, that when executed by the at least one processor, causes the electronic device to determine whether the data is ready for transmission based on the number of UEs in the first UE group and the number of UEs in the second UE group, further comprises program code, that when executed by the at least one processor, causes the electronic device to:
upon determining that the number of UEs in the first UE group is greater than zero and that that the number of UEs in the second UE group is greater than zero, determine whether to transmit the data, delay transmission of the data to a subsequent transmission time interval, or partition the data based on a total number of PRBs to transmit.
